(19) United States
(12) Patent Application Publication
(10) Pub. No.: US 2026/0120142 A1
(43) Pub. Date: Apr. 30, 2026

(54) System and Method for Optical-Wave Modeling of Customer Behavior in Marketing Ecosystems

(71) Applicant: Pelatro Pte. Ltd., Singapore (SG)

(72) Inventors: Arun Kumar Krishna, Bangalore (IN); Pramod Konandur Prabhakar, Bangalore (IN)

(21) Appl. No.: 19/375,760

(22) Filed: Oct. 31, 2025

Related U.S. Application Data
(60) Provisional application No. 63/714,444, filed on Oct. 31, 2024.

(51) Int. Cl. G06Q 30/0242; G06Q 30/0202

(52) U.S. Cl. CPC G06Q 30/0244; G06Q 30/0202

(57) ABSTRACT

A computer-implemented system and method model customer responsiveness to marketing initiatives using an optical wave-based simulation framework. Campaigns are encoded as incident light waves characterized by color (C), angle of incidence (θ), and intensity/weight (W), while customers are represented as optical media with per-entity vectors including refractive index (RIᵢ), reflection polarity (RPᵢ), response latency (RLᵢ), and absorption/reflection coefficients (αᵢ, ρᵢ). A simulation engine propagates campaign waves through a virtual medium, generates reflective/refractive/interference patterns under induced and involuntary noise, and captures resultant patterns on a virtual film as measurable effects. An analysis module infers sensitivity and reciprocity, classifies cohorts (e.g., aligned absorbers, inverted reflectors, delayed responders), and predicts drift likelihoods. Reinforcement learning adaptively refines campaign parameters and orchestration to minimize marketing noise and improve effectiveness. A workbench GUI supports configuration, experiment design, and export of audiences and metrics. The system ingests historical and streaming interaction data, operates across cloud/edge deployments, and is agnostic to industry, channel, and infrastructure.

### CROSS REFERENCE TO RELATED APPLICATIONS

To the full extent permitted by law, the present United States Non-Provisional Patent Application hereby claims priority to and the full benefit of, U.S. Provisional Application No. 63/714,444, filed Oct. 31, 2024, entitled “Quantitative techniques to infer customer sensitivity and reciprocity to marketing initiatives by using optical wave models in a digital ecosystem (Belaku)”, which is incorporated herein by reference in its entirety.

### FIELD OF THE DISCLOSURE

The present disclosure is directed to the organization, modeling, and analysis of user-relevant data arising from interactions between an organization and its users or customers, and to the leveraging of real-time and historical data to infer, predict, and influence behavioral responses. More specifically, the present disclosure provides a quantitative and geometric framework that represents marketing activities as optical wave phenomena within a simulated environment, enabling analysis of customer sensitivity, reciprocity, and marketing efficiency by interpreting light-wave interactions and corresponding behavioral outcomes.

The present disclosure is not limited to any particular computing architecture, file management system, data structure, or customer relationship platform. It may be implemented within or across any enterprise software system, networked computing infrastructure, or database framework, and is agnostic to programming language, hardware configuration, or type of user or organization. The system may operate in cloud-based, distributed, or localized digital ecosystems and may interoperate with existing analytical, visualization, or reinforcement learning modules.

### BACKGROUND OF THE DISCLOSURE

Telecommunications companies, software service providers, financial institutions, social media services, and other user-service-based businesses may generally have a large volume of customers, users, clients, and/or subscribers. Those businesses having such large customer volumes may further experience voluminous interactions with those customers, which may be enormous in scale and on a continuous basis. Data related to these interactions are valuable intellectual property to the businesses, often directly influencing their core products and services. However, technical challenges exist in making meaningful, context-aware use of such data, particularly in connection with real-time or evolving user behavior. Marketing is essential for businesses to reach and engage customers, yet it can often be wasteful, ineffective, or counterproductive. Excessive or misaligned marketing signals create interference, or “marketing noise,” that obscures useful patterns and diminishes responsiveness.

Recognizing the value of business data and the importance of marketing in driving growth, many organizations study, analyze, interpret, and act on customer-interaction data to guide marketing decisions. Marketing, however, has associated costs that accumulate across multiple domains—advertising production, media purchases, data analytics, campaign management software, and labor. These expenses are justified only to the extent that marketing interventions produce measurable, positive behavioral change in customers. In the absence of accurate causal or sensitivity models, organizations often rely on incomplete heuristics or retrospective analysis, leading to inefficiencies and systemic noise.

Evaluating marketing effectiveness remains complex. Approaches such as sales correlation, engagement tracking, A/B testing, and attribution modeling offer partial insights, but each suffers from confounding variables and limited interpretability. Conventional analytic techniques lack a unified geometric or physical representation that captures both the deterministic and stochastic nature of marketing interactions—how directed efforts (signals) interact with customer behavior (medium) under external perturbations (noise). Without such a framework, comparisons across campaigns, segments, or temporal contexts become cumbersome and prone to error.

The ideal in customer-centric marketing may be personalization at the “segment of one,” tailoring engagements uniquely to each individual. For organizations serving hundreds of millions of subscribers, achieving that precision requires not only large-scale data processing but also a coherent model that visualizes and quantifies the interplay between marketing effort and customer response. Existing marketing analytics tools typically focus on discrete statistical metrics rather than dynamic, interpretable systems capable of explaining why certain campaigns succeed or fail in real-world conditions.

Accordingly, there is a need for a comprehensive model that can geometrically or physically represent the universe of marketing activities and their resulting behavioral effects. In particular, a system that analogizes marketing initiatives to incident light waves and customers to optical media provides a structured means to observe, simulate, and analyze reciprocity, reflection, and refraction of engagement signals. Such an optical-wave framework can model both intentional and random phenomena, producing interpretable patterns that correspond to real-world marketing outcomes.

Through this wave-based approach, marketing interactions can be expressed as quantitative functions of light intensity, color spectrum, and angle of incidence, while customer behaviors are represented through refractive indices, reflection polarity, and absorption coefficients. This mapping enables measurement of responsiveness and sensitivity at the individual and aggregate levels, allowing enterprises to identify clusters of customers with similar behavioral traits, calibrate campaign parameters, and predict the likelihood of success under varying conditions.

Therefore, a need persists for a system and method for modeling, simulating, and analyzing marketing reciprocity and customer sensitivity using optical and wave-based analogies. The present disclosure addresses these challenges by providing a unified, physics-inspired framework that integrates geometric modeling, probabilistic inference, and reinforcement learning to quantify and interpret the effectiveness of marketing activities across large, complex digital ecosystems.

### SUMMARY OF THE DISCLOSURE

The present disclosure may solve the aforementioned limitations of existing systems and methods for analyzing marketing effectiveness by providing a system and method for quantitatively modeling and simulating customer sensitivity and reciprocity to marketing initiatives using optical-wave analogies within a digital ecosystem. These systems and methods may accomplish such by providing a comprehensive and quantifiable framework to represent marketing efforts, their behavioral effects, and the relative responses they generate. The present disclosure addresses these challenges by introducing a wave-centric geometric model that analogizes marketing activities to incident light waves and customers to optical media having distinctive refractive and reflective properties. Variations in light intensity, color, and angle of incidence are employed to represent differences in campaign intent, focus, and resource allocation.

With respect to the modeled effects of marketing activities, the system may translate behavioral and financial outcomes into a measurable function of reflection polarity, refraction angle, and absorption coefficients, each representing unique aspects of customer response. These may correspond to traditional business metrics such as Return on Investment (ROI), Customer Lifetime Value (CLV), or Customer Satisfaction (CSAT), as well as perceptual and temporal factors such as latency and resistance to influence. This formulation allows for simultaneous consideration of both profit-centric and experience-centric objectives when evaluating marketing performance.

Marketing efforts, such as campaigns, communications, or personalized nudges, may be encoded along an optical spectrum, wherein each wavelength corresponds to a marketing archetype or behavioral intent. Red-to-violet mappings may be employed to distinguish campaign objectives (e.g., sustain, grow, win-back), while intensity may represent the magnitude of effort or investment. The angle of incidence may further represent the engagement alignment between marketer and customer (e.g., an angle approaching 90°) signifying customer-initiated interest, while lower angles indicate marketer-initiated contact. Through these mappings, the system forms a reproducible model of multi-channel marketing behavior as a dynamic wave interaction.

Within the simulated environment, the system may further include a virtual medium corresponding to customer behavioral fluidity and randomness. Controlled perturbations or “ripples” may be induced to emulate stochastic market conditions, including competitor activity, macroeconomic shifts, and unplanned behavioral drift. By observing the resultant light patterns—including interference, reflection, and refraction phenomena—the system may infer the underlying distribution of customer sensitivities and engagement propensities. Reinforcement learning algorithms may then analyze these patterns to iteratively improve campaign calibration, predict marketing reciprocity, and distinguish voluntary responses from induced noise.

In operation, the system may incorporate a plurality of numerical, statistical, graphical, and machine-learning techniques applied to both historical and real-time interaction data. These techniques may include supervised learning for campaign classification, clustering for behavioral grouping, and reinforcement learning for adaptive optimization. The system may support real-time ingestion of multi-channel interaction data, the projection of campaign parameters as optical vectors, and the ongoing refinement of predictive and prescriptive strategies to enhance engagement alignment while minimizing wasted effort and marketing noise.

In one exemplary embodiment, the disclosed system may be implemented in a telecommunications enterprise to analyze customer responsiveness to recurring promotional campaigns, such as upgrades, data plan renewals, or loyalty offers. Each marketing initiative may be represented as an incident light wave of a defined color, intensity, and angle of incidence, and each customer may be modeled as an optical medium characterized by refractive index and reflection polarity. The resulting interference patterns projected onto a simulated film may reveal clusters of customers with similar sensitivities—such as those more responsive to cost incentives versus experience-oriented communications—allowing the operator to realign campaign vectors and reduce unproductive marketing noise.

In another exemplary embodiment, a financial institution may deploy the system to model client receptivity to product offerings such as insurance plans, investment portfolios, or credit card promotions. The system may interpret early interactions as low-intensity waves with shallow incidence angles, gradually increasing energy and frequency as customer engagement deepens. By observing reflection polarity and absorption coefficients, the system can differentiate clients who react inversely to overt solicitation (negative reflection) from those whose behavioral refractive index suggests delayed but positive adoption. Reinforcement learning feedback loops may adaptively refine campaign sequencing to optimize conversion without inducing cognitive overload or saturation.

In yet another embodiment, the invention may be applied to e-commerce and retail operations to evaluate real-time customer responsiveness to personalized recommendations, promotions, or cross-selling tactics. Each digital touchpoint—email, push notification, or in-app prompt—may be encoded as a light event whose wavelength and incidence correspond to content tone and delivery context. When aggregated across millions of users, resulting diffraction and interference patterns can indicate overlapping campaigns or conflicting signals. These insights enable marketing teams to synchronize promotional timing and intensity, thereby improving return on advertising spend and customer satisfaction.

In a further embodiment, the disclosed system may be implemented in a healthcare or wellness platform to optimize patient or subscriber engagement with treatment adherence programs, fitness challenges, or preventive screening reminders. The system may model behavioral resistance as an increase in optical density within the medium, allowing predictive inference of dropout risk or message fatigue. By applying adaptive reinforcement algorithms, the system can dynamically alter communication wavelength (tone) or intensity (frequency of engagement) to maintain receptivity while minimizing perceived intrusiveness or burnout.

In another example, the invention may be applied to social media, entertainment, or content-streaming ecosystems where algorithms continuously present users with recommendations, advertisements, or engagement prompts. In such embodiments, incident light waves may represent algorithmic suggestions or promoted content, while customer behavior is observed through the resulting reflection and refraction patterns, correlating to acceptance, skip, or rejection actions. By mapping and classifying interference zones—regions where overlapping content cues reduce effectiveness—the system can refine content sequencing and recommendation logic to align with inferred user preferences.

In one exemplary experimental embodiment, the disclosed system may be utilized for hypothesis testing of campaign tone and subtlety relative to customer refractive indices. For instance, a marketing analyst may propose the hypothesis that “subtle messaging produces higher engagement among customers exhibiting high refractive indices (RI) and low reflection polarity (RP)”. The system may divide a population into statistically comparable control and treatment groups based on prior behavioral data. The treatment group may receive lower-intensity communications at shallower angles of incidence, while the control group receives direct, high-intensity communications. The resulting optical patterns—represented by changes in reflected intensity, absorption coefficients, and latency of response—may be analyzed to validate or refute the hypothesis. If the hypothesis holds, reinforcement learning modules may encode this relationship as a rule, biasing future campaigns toward subtle, low-frequency outreach for similar customer archetypes.

In another exemplary embodiment, the system may facilitate hypothesis testing of multi-campaign interference effects. In this scenario, an organization may test whether overlapping promotional messages in adjacent time windows produce destructive interference that diminishes overall responsiveness. The hypothesis may be stated as “Concurrent campaigns targeting identical cohorts within the same period reduce aggregate engagement due to interference effects.” Within the simulated environment, two or more campaign vectors (each e.g., represented by distinct wavelengths and incidence angles) are propagated through the customer medium. The system observes whether resultant interference fringes correspond to declines in conversion or satisfaction metrics. The reinforcement learning engine may then iteratively adjust campaign phasing, frequency, and spectrum to minimize destructive overlap while preserving constructive reinforcement. This experiment provides actionable insight into campaign orchestration and temporal spacing for optimal marketing yield.

Beyond commercial use, the disclosed system may find applicability in public policy, education, or civic engagement systems, where large populations are exposed to awareness campaigns or behavioral nudges. By modeling message delivery, perception, and response as optical interactions, policymakers and analysts may identify which communities or demographic clusters exhibit high reflection (resistance), high absorption (compliance), or high diffusion (unpredictable response). These insights can guide communication strategies that are empirically adaptive, ethically calibrated, and resource-efficient, demonstrating the model's flexibility across both commercial and societal domains.

The foregoing illustrative summary, as well as other exemplary objectives and advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1A is a block diagram of a computer system of the present disclosure;

FIG. 1B is a block diagram of a communications system implemented by the computer system in FIG. 1;

FIGS. 2A-B are block diagrams of exemplary B2C communication/interaction systems of the disclosure;

FIG. 3, is a general schematic representation illustrative to wave behavior mapping;

FIG. 4 is a block diagram illustrating an exemplary software and module architecture;

FIG. 5A is a tabular diagram correlating marketing concepts to optical analog parameters;

FIG. 5B is a schematic and table illustrating the customer vector model;

FIG. 5C is a table illustrating campaign classifications across the visible spectrum;

FIGS. 6A-B are graphical interface representations illustrating campaign configuration screens; and

FIGS. 7A-7D are flow diagrams representing campaign testing.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

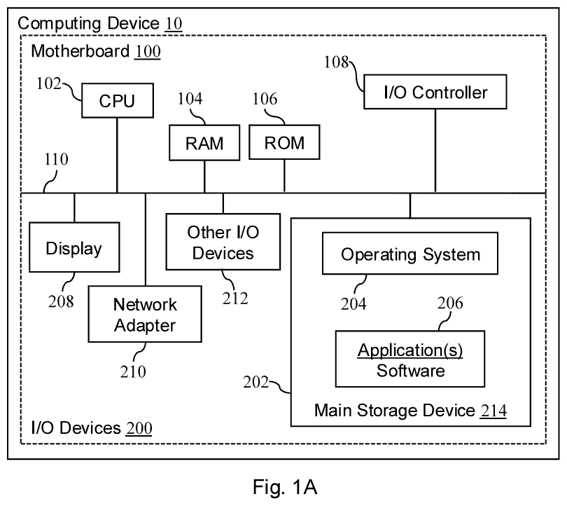

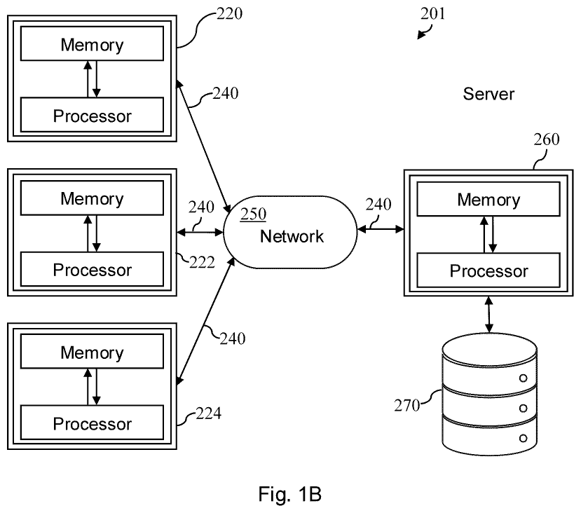

Referring now to FIGS. 1-7D, in describing the exemplary embodiments of the present disclosure, specific terminology is employed for the sake of clarity. Certain terms, as they may be relevant to the quantitative assessment of user and subscriber behaviors as well as business actions to elicit certain behaviors may be defined as follows. An interaction may mean any distinct/discrete touchpoint between a user/subscriber and a business at a specific time, though potentially with a plurality of purposes to achieve a business objective. Such interaction could come in many varieties, including an informational message, a phone call, a coupon, an offer for a new service addition, the like and/or combinations thereof. Engagement may mean a group of interactions having some cohesivity toward a business objective. A micro-journey may mean any activity experienced and/or performed by a user/subscriber which has a purpose in the mind of the user/subscriber. A journey may mean the interactions, engagements, micro-journeys, and other events between the user and business as may be observed by the business toward one or more business objectives. The present disclosure may use the terms customer, user, subscriber, consumer, and advocate interchangeably, and the disclosure is not so limited to those which an individual pays or otherwise financially rewards a business for provision of products and/or services, which may also be used interchangeably herein. Additionally, as may be important to the mathematical and trigonometric features of the disclosure, certain conventions for the naming of triangles may be observed and/or not included for purposes such as emphasis upon a specific angle, side, or other feature of such triangles. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. For clarity with later sections, references herein to “optical,” “wave,” “incidence,” “refraction,” “reflection,” and “interference” are analogical constructs implemented in software simulation to model marketing-customer interactions. The examples set forth herein are non-limiting examples and are merely examples among other possible examples.

The present disclosure addresses the aforementioned limitations of the currently available devices, computerized systems, and methods thereof for collecting, organizing, and curating customer engagements across multiple domains to provide contextual nurturing and alignment of customer journeys to business objectives by introducing an optical-wave simulation framework to infer customer sensitivity and reciprocity and to reduce unproductive marketing noise.

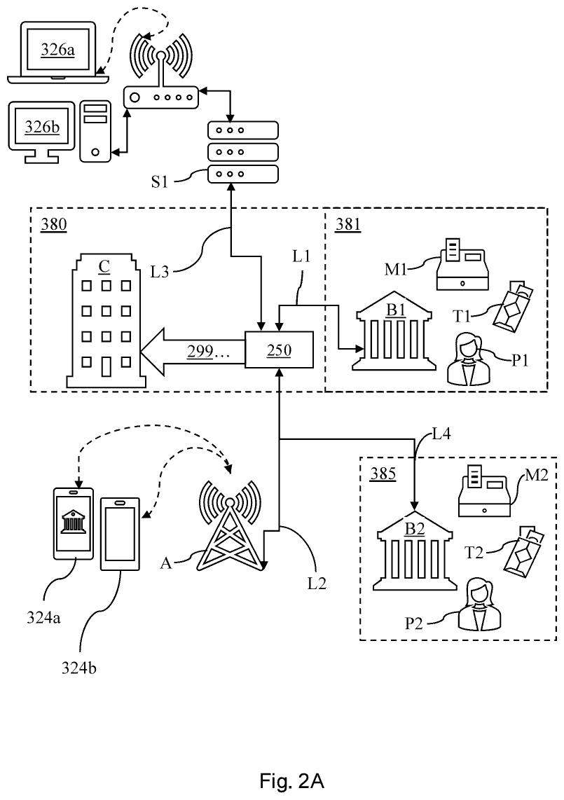

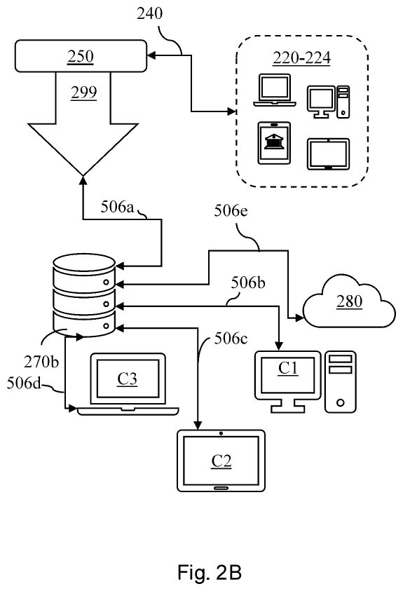

In describing the exemplary embodiments of the present disclosure, as illustrated in FIGS. 1A-1B, specific terminology is employed for the sake of clarity. The present disclosure, however, is not intended to be limited to the specific terminology so selected, and it is to be understood that each specific element includes all technical equivalents that operate in a similar manner to accomplish similar functions. The claimed invention may, however, be embodied in many different forms and should not be construed to be limited to the embodiments set forth herein. The examples set forth herein are non-limiting examples, and are merely examples among other possible examples. It should further be noted that with respect to FIGS. 1A-1B, FIGS. 2A-2B, as well as other Drawings of the disclosure, vast simplification of these techniques may be described herein in order to succinctly demonstrate various features of the disclosure, but applicability to larger, vastly more complicated systems may be achieved by those having ordinary skill in the art using other steps, features, systems, methods, and techniques as may be disclosed herein. Where appropriate, data-plane, control-plane, and experimentation-plane elements are shown conceptually; production deployments may distribute these across heterogeneous compute, storage, and network fabrics.

As will be appreciated by one of skill in the art, the present disclosure may be embodied as a method, data processing system(s), software as a service (SaaS), computer program product(s), artificial intelligence system(s), large language model(s), the like and/or combinations thereof. Accordingly, the present disclosure may take the form of an entirely hardware embodiment, an entirely software embodiment or an embodiment combining software and hardware aspects in order to solve the various technical problems with the various technical solutions as may be disclosed herein. Furthermore, the present disclosure may take the form of a computer program product on a computer-readable storage medium having computer-readable program code means embodied in the medium. Any suitable computer readable medium may be utilized, including hard disks, ROM, RAM, CD-ROMs, electrical, optical, magnetic storage devices and the like. In some embodiments, modules may be containerized microservices communicating over authenticated APIs with role-based access control.

The present disclosure is described below with reference to block and flowchart illustrations of methods, apparatus (systems) and computer program products according to embodiments of the present disclosure. It will be understood that each block or step of the flowchart illustrations, and combinations of blocks or steps in the flowchart illustrations, can be implemented by computer program instructions or operations. These exemplary computer program instructions, functions, equations, and/or operations may be loaded onto a general-purpose computer, special purpose computer, server, or other programmable data processing apparatus to produce a machine, such that the instructions or operations, which execute on the computer or other programmable data processing apparatus, create means for implementing the functions specified in the flowchart block or blocks/step or steps. Simulation blocks may include optical-analogy primitives (e.g., incidence-angle transforms, refractive-index estimators, reflection-polarity classifiers) and learning blocks (e.g., supervised models, clustering, and reinforcement learning).

These computer program instructions or operations may also be stored in a computer-usable memory that can direct a computer or other programmable data processing apparatus to function in a particular manner, such that the instructions or operations stored in the computer-usable memory produce an article of manufacture including instruction means which implement the function specified in the flowchart block or blocks/step or steps. The computer program instructions or operations may also be loaded onto a computer or other programmable data processing apparatus (processor) to cause a series of operational steps to be performed on the computer or other programmable apparatus (processor) to produce a computer implemented process such that the instructions or operations which execute on the computer or other programmable apparatus (processor) provide steps for implementing the functions specified in the flowchart block or blocks/step or steps. Accordingly, blocks or steps of the flowchart illustrations support combinations of means for performing the specified functions, combinations of steps for performing the specified functions, and program instruction means for performing the specified functions. It should also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions or operations. In distributed embodiments, certain steps may execute at the edge (e.g., user device telemetry collection) while policy and training steps execute in a centralized or cloud environment.

Computer programming for implementing the present disclosure may be written in various programming languages, database languages, the like and/or combinations thereof. However, it is understood that other source or object-oriented programming languages, and other conventional programming language may be utilized without departing from the spirit and intent of the present disclosure. Examples include, without limitation, Python, Java, C/C++, TypeScript, SQL/NoSQL query languages, and GPU-accelerated kernels for model training.

Referring now to FIG. 1A specifically, there is illustrated a block diagram of a simplified computing system 10 that provides a suitable environment for implementing embodiments of the present disclosure. The computer architecture shown in FIG. 1A, as may be well understood by those having ordinary skill in the art, is divided into two parts—motherboard 100 and the input/output (I/O) devices 200. Motherboard 100 preferably includes subsystems and/or processor(s) to execute instructions such as central processing unit (CPU) 102, a memory device, such as random-access memory (RAM) 104, input/output (I/O) controller 108, and a memory device such as read-only memory (ROM) 106, also known as firmware, which are interconnected by bus 110. A basic input output system (BIOS) containing the basic routines that help to transfer information between elements within the subsystems of the computer is preferably stored in ROM 106, or operably disposed in RAM 104. Computing system 10 further preferably includes I/O devices 202, such as main storage device 214 for storing operating system 204 and instructions or application program(s) 206, and display 208 for visual output, and other I/O devices 212 as appropriate. Main storage device 214 preferably is connected to CPU 102 through a main storage controller (represented as 108) connected to bus 110. Network adapter 210 allows the computer system to send and receive data through communication devices or any other network adapter capable of transmitting and receiving data over a communications link that is either a wired, optical, or wireless data pathway. It is recognized herein that central processing unit (CPU) 102 performs instructions, operations or commands stored in ROM 106 or RAM 104. In some embodiments, accelerator hardware (e.g., GPU, TPU, or NPUs) may be present to support optical-simulation workloads and model training.

Processor 102 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1A as a single processor, in some embodiments, processor 102 comprises a plurality of processors. The plurality of processors may be embodied on a single computing device or may be distributed across a plurality of computing devices collectively configured to function as the computing device 10. The plurality of processors may be in operative communication with each other and may be collectively configured to perform one or more functionalities of the computing device 10 as described herein. In an example embodiment, processor 102 is configured to execute instructions stored in memory 104, 106 or otherwise accessible to processor 102. These instructions, when executed by processor 102, may cause the computing device 10 to perform one or more of the functionalities of the computing device 10 as described herein. Workloads can include ingestion of interaction events, transformation into optical-analogy parameters, and execution of simulation and learning cycles.

Whether configured by hardware, firmware/software methods, or by a combination thereof, processor 102 may comprise an entity capable of performing operations according to embodiments of the present invention while configured accordingly. Thus, for example, when processor 102 is embodied as an ASIC, FPGA or the like, processor 102 may comprise specifically configured hardware for conducting one or more operations described herein. As another example, when processor 102 is embodied as an executor of instructions, such as may be stored in memory 104, 106, the instructions may specifically configure processor 102 to perform one or more algorithms and operations described herein. These may include, by way of example, angle-of-incidence computation, refractive-index estimation, reflection-polarity determination, interference detection, cohort clustering, and policy updates.

The plurality of memory components 104, 106 may be embodied on a single computing device 10 or distributed across a plurality of computing devices. In various embodiments, memory may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 104, 106 may be configured to store information, data, applications, instructions, or the like for enabling the computing device 10 to carry out various functions in accordance with example embodiments discussed herein. For example, in at least some embodiments, memory 104, 106 is configured to buffer input data for processing by processor 102. Additionally or alternatively, in at least some embodiments, memory 104, 106 may be configured to store program instructions for execution by processor 102. Memory 104, 106 may store information in the form of static and/or dynamic information. This stored information may be stored and/or used by the computing device 10 during the course of performing its functionalities. In some embodiments, feature stores and model artifacts are persisted in main storage device 214 or remote database 270 for reuse across experimentation cycles.

Many other devices or subsystems or other I/O devices 212 may be connected in a similar manner, including but not limited to, devices such as microphone, speakers, flash drive, CD-ROM player, DVD player, printer, main storage device 214, such as hard drive, and/or modem each connected via an I/O adapter. Also, although preferred, it is not necessary for all of the devices shown in FIG. 1A to be present to practice the present disclosure, as discussed below. Furthermore, the devices and subsystems may be interconnected in different configurations from that shown in FIG. 1A, or may be based on optical or gate arrays, or some combination of these elements that are capable of responding to and executing instructions or operations. The operation of a computer system such as that shown in FIG. 1A is readily known in the art and is not discussed in further detail in this application, so as not to overcomplicate the present disclosure with unnecessary recitations of well-known computing technologies. Security layers (e.g., encryption-at-rest/in-transit and audit logging) may be implemented without departing from the scope of FIG. 1A.

In some embodiments, some or all of the functionality or steps may be performed by processor 102. In this regard, the example processes and algorithms discussed herein can be performed by at least one processor 102. For example, non-transitory computer readable storage media can be configured to store firmware, one or more application programs, and/or other software, which include instructions and other computer-readable program code portions that can be executed to control processors of the components of system 201 to implement various operations, including the examples shown above. As such, a series of computer-readable program code portions may be embodied in one or more computer program products and can be used, with a computing device, server, and/or other programmable apparatus, to produce the machine-implemented processes discussed herein. Distributed execution across edge devices and centralized servers 260 is contemplated.

Any such computer program instructions and/or other type of code may be loaded onto a computer, processor or other programmable apparatuses circuitry to produce a machine, such that the computer, processor or other programmable circuitry that executes the code may be the means for implementing various functions, including those described herein. In some embodiments, model training leverages mini-batch processing and parallelization to meet latency targets.

Referring now to FIG. 1B, there is illustrated a diagram depicting an exemplary system 201 in which concepts consistent with the present disclosure may be implemented or performed. Those having ordinary skill in the art may recognize this, the previous, and remaining examples as heavily simplified for the purposes of illustration, especially in relation to the voluminous networked devices featured in examples of the disclosed system and method for optical-wave simulation framework for marketing reciprocity analysis. Examples of each element within the communication system 201 of FIG. 1B are broadly described above with respect to FIG. 1A. In particular, the server system 260 and user system 220 have attributes similar to computer system 10 of FIG. 1A and illustrate one possible implementation of computer system 10. Communication system 201 preferably includes one or more user systems 220, 222, 224, one or more server system 260, and network 250, which could be, for example, the Internet, public network, private network or cloud. User systems 220-224 each preferably include a computer-readable medium, such as random-access memory, coupled to a processor. The processor, CPU 102, executes program instructions or operations stored in memory. Communication system 201 typically includes one or more user system 220. For example, user system 220 may include one or more general-purpose computers (e.g., personal computers), one or more special purpose computers (e.g., devices specifically programmed to communicate with each other and/or the server system 260), a workstation, a server, a device, a digital assistant or a “smart” cellular telephone or pager, a digital camera, a component, other equipment, or some combination of these elements that is capable of responding to and executing instructions or operations. Edge collection agents may transform raw interactions into optical parameters prior to transmission.

Similar to user system 220, server system 260 preferably includes a computer-readable medium, such as random-access memory, coupled to a processor. The processor executes program instructions stored in memory. Server system 260 may also include a number of additional external or internal devices, such as, without limitation, a mouse, a CD-ROM, a keyboard, a display, a storage device and other attributes similar to computer system 10 of FIG. 1A. Server system 260 may additionally include a secondary storage element, such as database 270 for storage of data and information. Server system 260, although depicted as a single computer system, may be implemented as a network of computer processors. Memory in server system 260 contains one or more executable steps, program(s), algorithm(s), or application(s) 206 (shown in FIG. 1A). For example, the server system 260 may include a web server, information server, application server, one or more general-purpose computers (e.g., personal computers), one or more special purpose computers (e.g., devices specifically programmed to communicate with each other), a workstation or other equipment, or some combination of these elements that is capable of responding to and executing instructions or operations. In some embodiments, database 270 functions as a feature store and results repository for campaign vectors and customer vectors.

System 201 is capable of delivering and exchanging data between user system 220 and a server system 260 through communications link 240 and/or network 250. Through user system 220, users can preferably communicate over network 250 with each other user system 220, 222, 224, and with other systems and devices, such as server system 260, to electronically transmit, store, manipulate, and/or otherwise use data exchanged between the user system and the server system. Communications link 240 typically includes network 250 making a direct or indirect communication between the user system 220 and the server system 260, irrespective of physical separation. Examples of a network 250 include the Internet, cloud, analog or digital wired and wireless networks, radio, television, cable, satellite, and/or any other delivery mechanism for carrying and/or transmitting data or other information, such as to electronically transmit, store, manipulate, and/or otherwise modify data exchanged between the user system and the server system. The communications link 240 may include, for example, a wired, wireless, cable, optical or satellite communication system or another pathway. It is contemplated herein that RAM 104, main storage device 214, and database 270 may be referred to herein as storage device(s) or memory device(s). Data transmissions may be encrypted and compressed; streaming interfaces (e.g., message queues) may be employed for real-time ingestion.

With respect to FIG. 2A, therein illustrated is a block chart of an exemplary intake ingestion scheme of the exemplary telecommunication network and computerized services infrastructure, which may access or be in receipt of certain financial, social media, entertainment, or other networks via datastream 299 as may be herein described and/or recognized by those having ordinary skill in the art, and may be described in a basic exemplary embodiment in FIG. 2A. Basic components, which may or may not be required depending on the users/systems/subscribers/customers/content being monitored, studied, or stored, are exemplary only. A system and method according to the disclosure may be and likely is more complicated than may be illustrated in FIGS. 1A, 1B, 2A, 2B and otherwise, and may involve multiple (or numerous) towers, user devices, networks, servers, users, the like, and/or combinations thereof as may be understood by those having ordinary skill in the art. Beginning with various subscriber/user interaction(s) with various telecommunications and other computerized services infrastructure, first subscriber device 324a and second subscriber device 324b may each interact with antenna A (via wired or wireless connections), which may in turn transmit data and/or communicate via telecommunication line L2 with, for example, corporate servers C via network 250, which may or may not form a part of, for instance, the Internet, and other devices on network 250, which may reside on corporate network infrastructure 380, which may include exemplary database 270b, user systems 220, 222, 224 and agent systems C1-C3 (see FIG. 2B) via e.g., network lines 240 (see FIG. 1B) or communication links L1-L4. As may be understood by those having ordinary skill in the art, certain subscriber devices, such as e.g., first subscriber device 324a, may feature a mobile application configured to perform certain functions within the services domain of the business and communicate therewith via a credentialling system, which may be secure. Additionally, other user devices, such as laptop 326a, desktop 326b, and external server S1 may communicate similarly to network 250 and so on. Importantly, various branches of a business may operate via public and/or private networks to network 250, such as branch office B1 and branch office B2, which may feature among connected branch devices 381 and connected branch devices 385, respectively, through use of POS systems M1-M2, automated customer machines T1-T2, and branch associate machines P1-P2. Each such branch environment may serve as a localized emitter or receptor of marketing stimuli within the broader optical-wave simulation model, wherein activities, transactions, and communications recorded at each node contribute to the generation of wavefronts within the system's behavioral modeling layer. Obviously, a high volume system, such as those designed to benefit from the disclosed system and method for optical-wave modeling may be much more complicated than the elementary network examples provided herein, and may feature many hundreds or even millions of such exemplary devices as illustrated herein, and be connected via means known by those having ordinary skill in the art. By way of example and not limitation, such networks may take the form of private networks, virtual private networks, secure connections on the Internet or the Web, the like, and/or combinations thereof. These systems and the various communications and/or transactions thereof in communication with corporate servers C may obtain vast quantities of data via one or more of datastream 299, such that customer/user interactions may be received, stored, catalogued, analyzed, reported, and otherwise acted upon as may be herein described. Within the context of the present disclosure, these data interactions may be modeled as incident or reflected waves, wherein transmission lines L1-L4 and datastream 299 conceptually correspond to propagation vectors, and the network infrastructure acts as the medium through which the simulated energy (representing marketing effort or response) travels and interferes. The above communications and computerized services environment, at least with respect to the disclosed system and method for simulating, analyzing, and optimizing marketing reciprocity and customer sensitivity through optical-wave analogies and multidimensional geometry, its features and benefits, and potential implementations may be even better understood by those having skill in the art from a review of the remaining FIGS. 2B-7D, in addition to the accompanying Detailed Description.

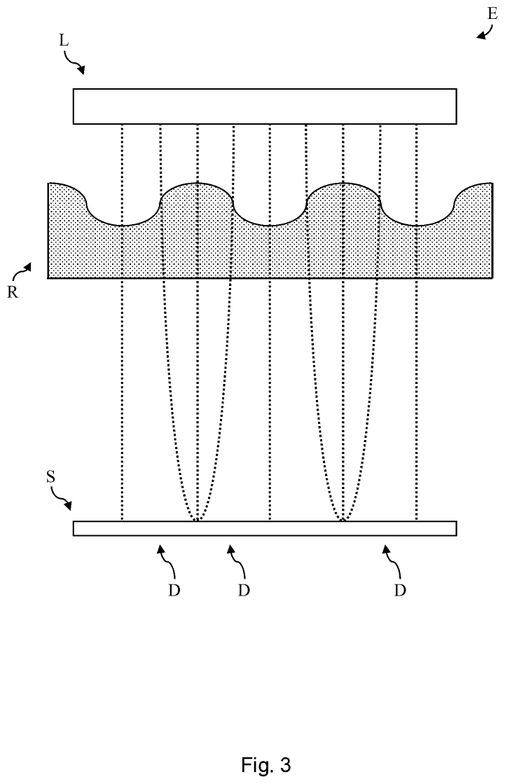

Referring now specifically to FIG. 2B, therein illustrated is a block diagram of exemplary business-to-consumer (B2C) communication/interaction system of the disclosure in receipt of datastream 299 via network 250 as described above. As may be understood by those having ordinary skill in the art, one or more exemplary database 270b may be the primary recipient of comprehensive data, from e.g., user systems or devices 220-240, much of which may be relevant to transactions, communications sent/received, information thereof, and other services performed by the company, which may be relevant to the overall performance and interests of the company as may be herein described. Such datastream 299 may be received via communications link 506a by exemplary database 270b, where it may be again transmitted via appropriate channels to accomplish such transactions and/or services. Exemplary database 270b may further feature comprehensive and/or sophisticated hardware and software installed thereon to perform the various tasks, analyses, data transformations, and computations as may be herein described and may in turn communicate the results thereof or receive instructions to perform such tasks to and/or from corporate systems C1-C3, and such communications may be accomplished via links 506b, 506c, and 506d, respectively. Additionally, certain other devices owned and/or authorized by the company to access, process, or otherwise perform tasks upon such data within datastream 299 may do so through private cloud 280, which may further be connected to exemplary database 270b, or alternatively through private and/or secure connections thereof via network 250. In operation, the system may transform incoming datastream 299 into modeled waveforms representing campaign vectors and customer vectors, which are propagated through virtualized media defined by the corporate systems C1-C3 and visualized within the optical-wave simulation framework of the invention. The above communications and computerized services environment as illustrated herein FIG. 2B, as well as those described above in relation to FIG. 2A, at least with respect to the disclosed system and method for wave-based modeling of campaign vectors (color C, angle θ, intensity W) and customer vectors (RIᵢ, RPᵢ, RLᵢ, αᵢ, ρᵢ), its features and benefits, and potential implementations may be further understood by those having skill in the art from a review of the remaining FIGS. 3-7D, in addition to the accompanying Detailed Description.

Turning to FIG. 3, illustrated therein is a general conceptual representation illustrative to wave behavior mapping. FIG. 3 is a conceptual illustration useful for understanding the overall experimental framework E in which uniform illumination interacts with a modulated surface to produce a measurable pattern of variation. In the illustrated configuration, light source L directs illumination toward rippled transparent object R, having a surface geometry characterized by periodic undulations. The transmitted light is projected onto surface S, producing alternating bright and dark regions D that correspond to areas of constructive and destructive interaction. This configuration is analogous to a traditional ripple-tank experiment, in which light passes through a shallow body of water to cast moving light and dark patterns upon a viewing surface below. As the water surface varies in curvature, the light intensity projected below changes accordingly, forming visible patterns that reveal reflection, refraction, and diffraction behavior. Similarly, in the context of the present experimental framework E, FIG. 3 conceptually demonstrates how a uniform input may, when propagated through an irregular or responsive medium, yield differentiated outputs observable as patterned variations on surface S. The illustration is not intended to represent an actual optical or physical apparatus, but rather to serve as an analogy for how non-uniform response characteristics may emerge from a nominally uniform excitation. In the context of the system described herein, light source L may analogize to a source of marketing stimuli or campaign effort, rippled object R may represent a population or behavioral response field having non-uniform receptivity, and surface S may correspond to an outcome or observation layer in which measurable results are projected. The alternating bright and dark regions D thus correspond to areas of higher and lower engagement, conversion, or response intensity. Accordingly, FIG. 3 serves to conceptually illustrate how even uniform marketing efforts may, when propagated through a non-uniform audience topology, yield distinct and quantifiable variations in performance across a modeled response surface, but a more precise understanding of these concepts as they may relate to the disclosed system and method for optical-wave modeling of customer behavior in marketing ecosystems.

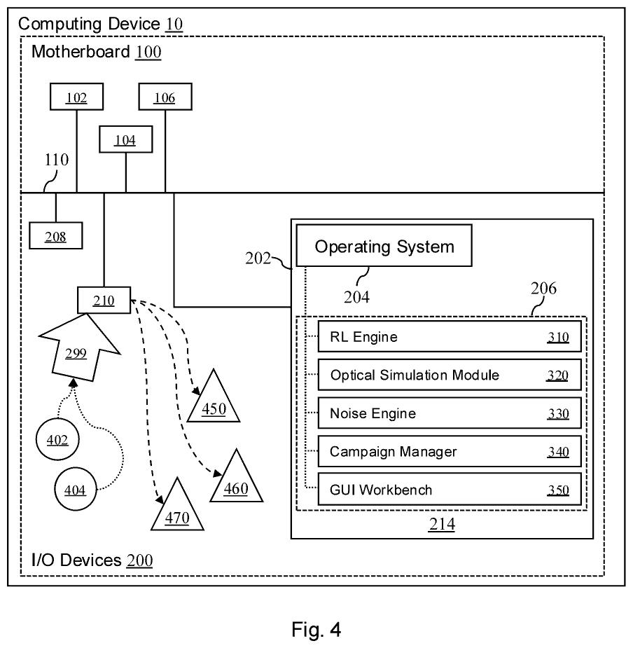

Turning to FIG. 4, illustrated therein is a block diagram illustrating an exemplary software and module architecture executing on computing device 10. Generally, FIG. 4 may be understood to schematically illustrate reinforcement learning engine 310, optical simulation module 320, noise engine 330, campaign manager 340, and graphical user interface (GUI) workbench 350, interconnected with operating system 208 and system bus 110, or substantially the same hardware configuration as that shown and described in FIG. 1A, but further illustrating the inclusion of an integrated software stack and data ingestion workflow adapted for the present disclosure. As shown, motherboard 100 includes processor 102, random access memory (RAM) 104, read-only memory (ROM) 106, and I/O controller 108, interconnected by system bus 110, which collectively support the execution of an operating system 204 and an application stack 206 stored on main storage device 214. Datastream 299 represents a continuous or event-driven flow of inbound data (e.g., user interactions, transactions, marketing actions, or engagement events) received via network adapter 210 from one or more external sources 402, 404, and transformed into structured or unstructured datasets suitable for processing. The datastream may be directed into internal memory or storage and may invoke one or more applications or modules within the software stack for execution. The illustrated application stack 206 may include reinforcement learning (RL) engine 310, optical simulation module 320, noise engine 330, campaign manager 340, and graphical user interface (GUI) workbench 350, which collectively form the operational framework for simulation, analysis, and control. RL engine 310 may implement decision and feedback loops, enabling the system to evaluate the effectiveness of marketing or behavioral strategies through reinforcement-based policies. Optical simulation module 320 may perform transformations of marketing data into wave-based analog models, generating simulated propagation, reflection, and interference patterns corresponding to customer or subscriber behavior. Noise engine 330 may quantify and inject controlled stochasticity to emulate environmental or contextual variance observed in real-world markets, while campaign manager 340 may coordinate execution and alignment of campaign parameters, inputs, and objectives. GUI workbench 350 may provide a visualization and control layer permitting human operators to observe and refine simulation outputs, entropy measurements, and campaign adjustments in real time. Processed outputs and derived variables, represented illustratively by reference numerals 450, 460, and 470, may denote transformed data artifacts or intermediate model states generated by the system as part of a simulation or optimization cycle. Such outputs may include multi-dimensional representations of campaign vectors, customer vectors, or entropy-based performance metrics, which are persistently stored in main storage device 214 or transmitted to remote repositories for subsequent analysis. Operating system 204 coordinates the operation of the above modules and supports multi-threaded and parallelized execution of simulation and learning workloads. In certain embodiments, processor 102 may utilize dedicated accelerator hardware (e.g., GPU, TPU, or NPU) to perform tensor computations and matrix transformations associated with the optical simulation or reinforcement learning modules. The architecture shown in FIG. 4 thereby enables computing device 10 to perform ingestion, transformation, and analysis of datastream 299 while simulating market-level behaviors using optical analogies as described throughout the disclosure.

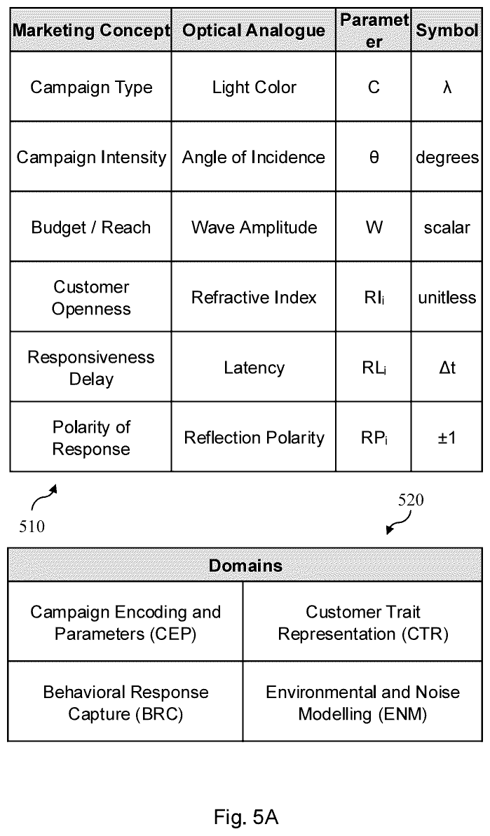

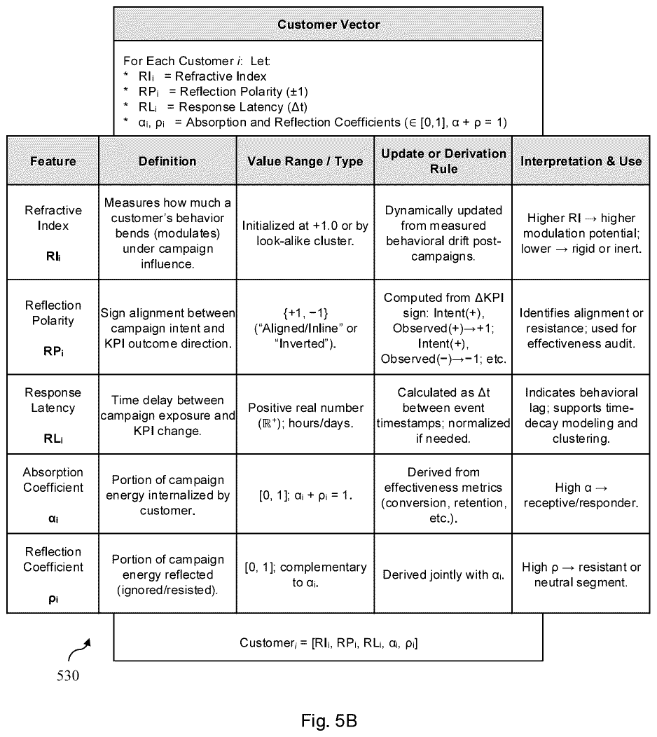

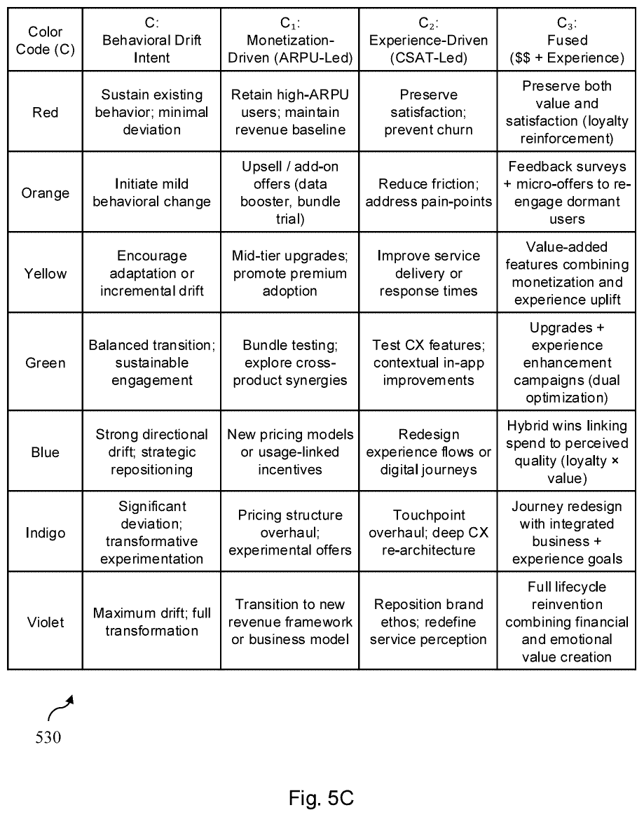

Turning to FIG. 5A, illustrated therein is a tabular diagram correlating marketing concepts to optical analog parameters. Generally, these include, mapping campaign type, intensity, budget, customer openness, responsiveness delay, and reflection polarity to corresponding symbols and measurement units. Conceptual parameterization table 510 may define the analogical correspondence between marketing constructs and physical properties as modeled within the present system. As shown, each marketing concept may be associated with an optical analogue, a measurable or simulated parameter, and a corresponding symbolic representation used in computational modeling. Beneath table 510, FIG. 5A further includes a domain structure 520 defining the four primary subdomains of the systems and methods of the disclosure, namely, Campaign Encoding and Parameters (CEP), Customer Trait Representation (CTR), Behavioral Response Capture (BRC), and Environmental and Noise Modeling (ENM), which collectively may organize the system's functional architecture for simulation, analysis, and feedback. The table establishes the foundational mappings for what is referred to herein as the Optical Model, which forms one of the two primary metaphoric subsystems of the disclosed framework, the other being a pulse reflection model. A pulse reflection model describes how a pulse, such as a wave on a string or a voltage pulse in a cable, behaves when it encounters a boundary. The model shows that the pulse can be partially transmitted and partially reflected, with the nature of the reflection depending on the properties of the boundary. A reflection at a fixed or “hard” boundary results in an inverted pulse, while a reflection at a free or “soft” boundary does not invert the pulse.

In the Optical Model, marketing campaigns can be treated as incident light beams, while customer populations or individual subscribers can be treated as optical media through which such light passes. As shown in FIG. 5A, campaign type may correspond to light color (C, symbol λ), campaign intensity to angle of incidence (θ, expressed in degrees), and budget or reach to wave amplitude (W, expressed as a scalar magnitude). Similarly, customer openness can be modeled as refractive index (RIᵢ), a unitless quantity representing relative receptivity or transparency of the behavioral medium; responsiveness delay corresponds to latency (RLᵢ), representing temporal displacement or lag (Δt) between stimulus and response; and polarity of response is represented as reflection polarity (RPᵢ), denoting whether the observed behavior is directionally aligned or inverted relative to campaign intent, symbolized as ±1. These mappings may preferably not assert any physical causality between optical phenomena and human behavior, but rather serve as formalized metaphors enabling the translation of abstract behavioral attributes into measurable parameters within a simulation space. Through these analogues, customer-campaign interactions may be modeled as the propagation of light through non-uniform media, where differences in refractive index and reflection polarity produce measurable interference, attenuation, or amplification effects.

In operation, these parameters form the inputs to optical simulation module 320 of FIG. 4, where incident “light” waves representing marketing campaigns interact with virtualized customer media characterized by distinct RIᵢ, RLᵢ, and RPᵢ values. The result is a set of computationally derived interference and reflection patterns conceptually similar to those illustrated in FIG. 3, wherein bright and dark regions D correspond to high and low response intensities, respectively. These modeled behaviors may be further evaluated by the reinforcement learning engine 310 to refine campaign attributes, align message vectors, and reduce systemic marketing entropy across cohorts. Thus, FIG. 5A provides a formalized schema through which marketing phenomena may be represented as optical-wave constructs, enabling systematic experimentation, trait inference, and interpretability in telco-scale or enterprise marketing systems. In exemplary telecom implementations, the system normalizes campaign evaluation around two principal key performance indicators—Average Revenue Per User (ARPU) and Customer Satisfaction (CSAT), which may serve as reference axes for measuring positive or inverted polarity of response.

Complementing the Optical Model, the Pulse Reflection Model provides a directional and temporal interpretation of customer response. Whereas the Optical Model may conceptualize campaign-customer interactions as continuous wave propagation through an irregular medium, the Pulse Reflection Model may instead treat each marketing event as a discrete impulse, more analogous to a wave pulse transmitted toward a reflective surface and observed through the characteristics of its return signal. The purpose of this model may be to capture whether a recipient's behavioral response is directionally aligned with the intent of the originating campaign and to quantify latency between the outbound stimulus and the inbound behavioral change. In this model, each campaign event may be encoded as a stimulus pulse having a definable amplitude, polarity, and temporal signature. The subsequent customer response—whether engagement, purchase, deflection, or resistance—is interpreted as a reflected pulse, which may be classified according to its polarity (RPᵢ) and latency (RLᵢ). A positive polarity (+1) denotes alignment with campaign objectives (e.g., an increase in adoption, satisfaction, or conversion), while a negative polarity (−1) denotes inversion or resistance (e.g., churn, complaint, or disengagement). The latency term (Δt) measures the elapsed time between emission and reflection, corresponding to the delay between campaign delivery and measurable behavioral impact. By aggregating and analyzing these reflections across a population, the system identifies patterns of directional coherence and temporal clustering, allowing it to infer group-level behavioral tendencies such as habitual alignment, resistance, or delayed responsiveness. These traits are then fed into the reinforcement learning engine 310 (see FIG. 4) for adaptive policy refinement, enabling the system to increase campaign efficiency while minimizing wasted effort in low-receptivity segments.

The Pulse Reflection Model thereby complements the Optical Model by emphasizing response directionality and feedback timing, rather than propagation and interference. Together, the two models provide a unified analytical framework through which the system can simulate and interpret marketing phenomena using structured, physics-inspired analogies. The Optical Model explains how a campaign diffuses through a population; the Pulse Reflection Model explains how and when the population reacts. When combined, they form the foundation for behavioral inference, campaign optimization, and entropy reduction across large-scale marketing ecosystems. Computationally, both the Optical Model and Pulse Reflection Model may be instantiated within the optical simulation module 320 and reinforcement learning engine 310 of FIG. 4, which together transform these conceptual analogies into quantifiable numerical series. Each campaign instance may then encoded as a multidimensional vector comprising its corresponding optical parameters (C, θ, W) and behavioral reflection parameters (RIᵢ, RLᵢ, RPᵢ). These values form the constituent elements of a dynamic dataset in which each customer or subscriber may be represented as a distinct medium characterized by its refractive and reflective properties. The system then generates a temporal series of simulated wave interactions across this medium, calculating resultant amplitudes, latencies, and reflection magnitudes. From these evolving parameters, an entropy value is derived to represent the degree of disorder, interference, or inefficiency present within the active marketing environment. Together, the Optical Model and Pulse Reflection Model operate as interleaved inference layers (one describing propagation and interference, the other describing directional alignment and latency) to enable both continuous and discrete interpretation of marketing response behavior, thereby improving measurable return on investment (ROI) through entropy reduction and suppression of marketing noise. It should be noted, in certain embodiments, campaign angle θ may further be derived from a quadrant-based framework that classifies interactions according to whether intent is known or unknown and whether the event is customer-or marketer-initiated. Customer-initiated interactions with known intent may be modeled at θ≈90°, while marketer-initiated outreach with unknown intent is modeled at lower θ values, thereby encoding engagement alignment geometrically, as may be further understood by reviewing domain structure 520 as illustrated therein FIG. 5A.

Turning specifically to the domain structure 520 of FIG. 5A, illustrated therein are the four operational domains comprising the systems and methods of the disclosure. The first domain, Campaign Encoding and Parameters (CEP), defines how each marketing activity is encoded as an optical construct using variables such as color (C), angle of incidence (θ), and wave amplitude (W) to represent campaign tone, directionality, and magnitude. The second domain, Customer Trait Representation (CTR), models individual or cohort-level behavioral attributes as latent optical variables including refractive index (RIᵢ), reflection polarity (RPᵢ), response latency (RLᵢ), and absorption and reflection coefficients (αᵢ, ρᵢ). The third domain, Behavioral Response Capture (BRC), governs the observation layer in which changes to primary key performance indicators such as ARPU and CSAT, as well as drift direction, latency, and magnitude, are measured following campaign exposure. Finally, the fourth domain, Environmental and Noise Modeling (ENM), accounts for stochastic and interference phenomena—both induced and involuntary—representing real-world market variability and overlapping campaign effects. Together, these four domains provide a modular, physics-inspired architecture that operationalizes the Optical Model within the reinforcement learning environment of FIG. 4, enabling repeatable experimentation and interpretability of marketing dynamics across population scales. This entropy quantification enabled by the frameworks of table 510 and domain structure 520 serves as a diagnostic and optimization metric, guiding the reinforcement learning engine toward equilibrium conditions of maximal efficiency and minimal behavioral uncertainty, which may be best understood after review of the remaining Drawings and relevant Detailed Description.

Turning to FIG. 5B, illustrated therein is a schematic and table 530 illustrating the customer vector model. Generally, each customer “i” may be defined by the parameters refractive index RIᵢ, reflection polarity RPᵢ, response latency RLᵢ, absorption coefficient αᵢ, and reflection coefficient ρᵢ, along with corresponding interpretation, update rules, and behavioral meaning. Collectively, these may be understood and/or used to describe behavioral modulation, alignment, temporal responsiveness, and energy distribution under campaign exposure. As understood by those having ordinary skill in the art, these parameters may be dynamically updated over time to reflect changing behavioral tendencies and campaign outcomes.

Beginning with the refractive index (RIᵢ), it may quantify the extent to which a customer's behavior bends or modulates under marketing influence, analogous to how light refracts when passing through a medium of varying density. A higher RIᵢ may indicate greater behavioral flexibility or susceptibility to influence, whereas a lower RIᵢ may correspond to inertia or resistance. This value may be initialized at +1.0 or estimated through clustering of look-alike behavioral cohorts and is dynamically updated following campaign exposure using longitudinal drift measurements. Turning to the reflection polarity (RPᵢ), it may represent the directional alignment of a customer's behavioral response relative to campaign intent. A polarity value of +1 (aligned or “inline”) could be used to indicate that the customer's behavior changes in the intended direction (e.g., higher engagement or adoption), whereas −1 (inverted) could instead indicate a counter-directional response (e.g., disengagement or churn). The system can determine RPᵢ by comparing the sign of the change in key performance indicators (ΔKPI) such as Average Revenue Per User (ARPU) or Customer Satisfaction (CSAT) against the campaign's expected outcome vector. With regard to the response latency (RLᵢ), it may represent a time delay between campaign exposure and measurable behavioral change, analogous to signal delay in optical transmission. RLᵢ is calculated as the elapsed time (Δt) between event timestamps corresponding to the campaign initiation and the first detectable KPI movement. This parameter supports the modeling of temporal inertia, time-decay functions, and segmentation based on responsiveness speed. Turning to the absorption coefficient (αᵢ) and reflection coefficient (ρᵢ), these may represent complementary proportions of campaign energy internalized versus rejected by the customer. The two coefficients are constrained such that αᵢ+ρᵢ=1. A high αᵢ indicates a receptive or responsive customer segment that effectively converts campaign exposure into behavioral change; a high ρᵢ indicates a resistant or neutral segment that reflects or ignores the influence. These coefficients are derived from normalized effectiveness metrics such as conversion rate, retention, or repeat interaction frequency, and may be updated iteratively as new behavioral data is captured. The resulting customer vector is formally represented as:

Customerᵢ=[RIᵢ, RPᵢ, RLᵢ, αᵢ, ρᵢ]. Each vector may form an observation point in a higher-dimensional behavioral space, where clustering and trajectory analysis allow the system to infer longitudinal behavioral drift, align campaign timing with receptive phases, and quantify entropy in response distributions. Conceptually, these optical-behavioral parameters may serve as both measurement and inference constructs, enabling the system to express complex marketing interactions using structured, physics-inspired variables. Through continuous observation, each customer's optical profile evolves over successive campaign cycles, allowing reinforcement learning algorithms to recalibrate campaign vectors and reduce behavioral uncertainty. The structure shown in FIG. 5B therefore provides the quantitative foundation of the system and method for optical-wave modeling of customer behavior in marketing ecosystems, linking the physical metaphors introduced in FIG. 3 with the computational entropy framework described in subsequent sections.

Turning to FIG. 5C, illustrated therein is a color-coded table illustrating campaign classifications across the visible spectrum. Generally, FIG. 5C may show color codes across various campaign types C₁-C₃, which may correspond to monetization-driven, experience-driven, and fused campaign archetypes, each described by marketing intent and behavioral drift objective. In FIG. 5C, there is illustrated a table 530 depicting the Color Code (C) hierarchy used within the system and method for optical-wave modeling of customer behavior in marketing ecosystems of the disclosure to categorize campaigns according to their behavioral intent, economic orientation, and experiential objectives. In such a proposed schema, each color can encode a distinct behavioral drift vector, representing the magnitude and direction of desired customer-state change, and aligns with three operational subdomains: C₁: Monetization-Driven (ARPU-Led), C₂: Experience-Driven (CSAT-Led), and C₃: Fused ($$+Experience). This spectrum-based taxonomy enables systematic encoding of campaign strategies for use within the optical simulation module, where each color corresponds to a modeled wavelength and amplitude of marketing influence. Beginning with the Red region, it may correspond to customer vectors in campaigns designed for behavioral preservation, wherein minimal drift is desired. In the C₁ context, red-coded campaigns emphasize retention of high-ARPU users and maintenance of baseline revenue, typically through loyalty credits or status rewards. In the C₂ context, such campaigns may alternatively seek to preserve satisfaction and prevent churn by reinforcing consistency and reliability in customer experience. The C₃ fused interpretation aligns these goals—reinforcing both financial stability and perceptual trust, which may represent the most stable, least disruptive, most preferred state in the optical analogy (low amplitude, near-normal incidence). The Orange region may be implicated when a customer vector indicates a mild behavioral change, stimulating engagement without major strategic repositioning. Monetization-led (C₁) campaigns may include upsell or add-on offers, such as data boosters or bundle trials, which slightly increase spend while maintaining familiarity. Experience-led (C₂) campaigns at this level reduce friction or address pain points, signaling early responsiveness to user dissatisfaction. The fused (C₃) configuration often employs micro-offers or survey-driven re-engagement to reactivate dormant customers, which may represent low-frequency wave perturbations intended to produce measurable, but limited, behavioral displacement. The Yellow region can signify incremental drift or adaptive progression, where moderate behavioral change is desirable. In C₁, campaigns may focus on promoting mid-tier upgrades or premium service adoption to elevate ARPU in a predictable manner. In C₂, such campaigns may enhance service delivery or shorten response times to improve user satisfaction metrics. The C₃ form of yellow-coded campaigns unites these aims by offering value-added features that combine incremental monetization with experience uplift, by creating stable constructive interference between financial and perceptual signals. The Green region may then correspond to balanced transition and sustainable engagement, representing a midpoint in the behavioral spectrum. Monetization-driven campaigns at this level test pricing bundles or explore cross-product synergies, while experience-driven efforts test contextual features or introduce experience improvements via controlled in-app trials. The C₃ fused equivalent optimize the dual outcomes of enhancing customer satisfaction while maintaining revenue efficiency, analogous to optical resonance, where amplitude and phase are harmonized for maximum propagation efficiency. The Blue region can then indicate strong directional drift or strategic repositioning. Monetization-driven (C₁) campaigns may test new pricing models or usage-linked incentives to reframe user value perception. Experience-driven (C₂) campaigns may redesign interaction flows, digital journeys, or onboarding processes to elicit deeper emotional engagement. The C₃ variant integrates these by linking perceived quality to financial spend, seeking hybrid loyalty dynamics where users attribute value both to experience and expenditure, or a higher-energy wavelength within the optical framework producing distinct behavioral interference bands. The Indigo region may capture transformative experimentation, characterized by significant behavioral deviation and large drift magnitude. Monetization-led (C₁) initiatives may involve pricing structure overhauls or experimental revenue models. Experience-led (C₂) programs often include deep customer experience (CX) re-architecture or end-to-end journey redesign. The fused (C₃) interpretation merges financial and experiential restructuring, establishing new behavioral baselines through journey reinvention—analogous to refraction through a high-index medium where both angle and velocity of propagation change markedly. The Violet region then may represent maximum drift and full transformation, denoting the upper bound of campaign-induced behavioral change. Monetization-led (C₁) campaigns at this level may typically involve transitions to entirely new revenue frameworks or business models, while experience-led (C₂) campaigns focus on redefining the brand ethos or perception of service. The fused (C₃) variant embodies comprehensive lifecycle reinvention, combining financial transformation with emotional resonance and long-term brand realignment, representing the highest optical frequency and energy state within the behavioral spectrum. Then, each decision across the C-C₃ matrix in FIG. 5C may therefore be selected to represent a distinct campaign archetype, enabling the system to classify and model behavioral intent as a function of wavelength, amplitude, and incidence within the optical simulation space. It should be noted, the environmental and noise modeling domain may distinguish between induced noise (intentionally introduced for controlled experimentation) and involuntary noise (arises naturally from market or competitor dynamics). Both forms may be characterized within the system as solo, multiple, or overlapping ripple types inferred from changes in customer behavioral, spend, and engagement patterns. When propagated through the customer field described in FIG. 5B, these encoded campaigns yield measurable interaction patterns, enabling the system to evaluate effectiveness, interference, and entropy variation across behavioral clusters, as may be understood more thoroughly from a review of the remaining Drawings and Detailed Description.

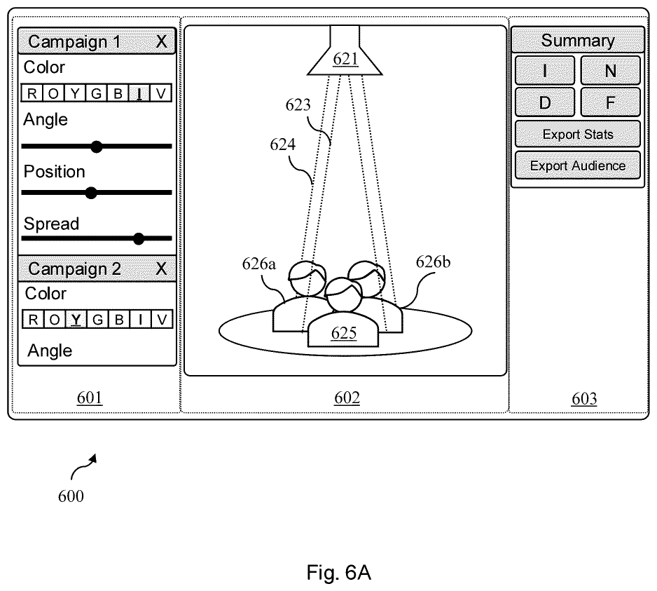

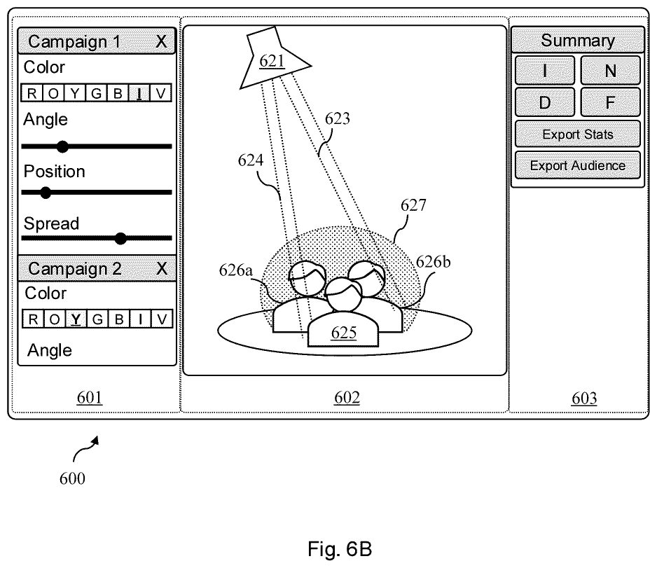

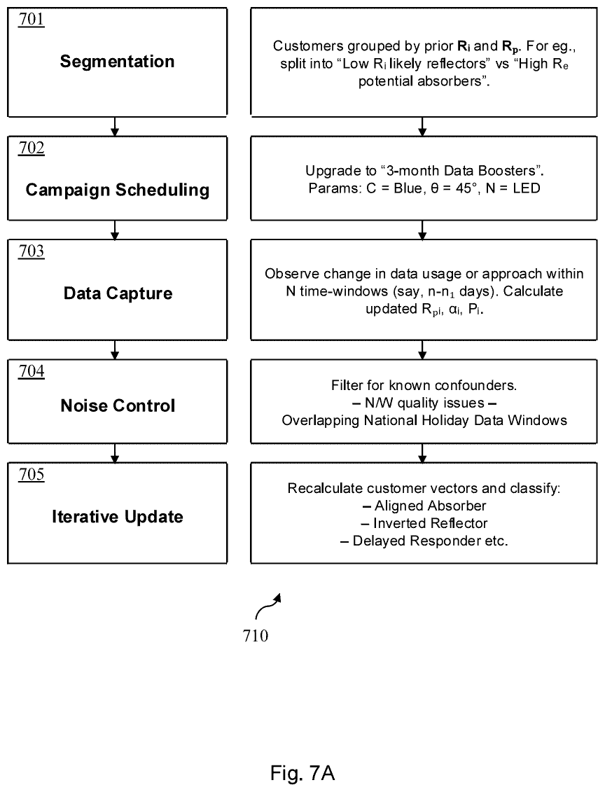

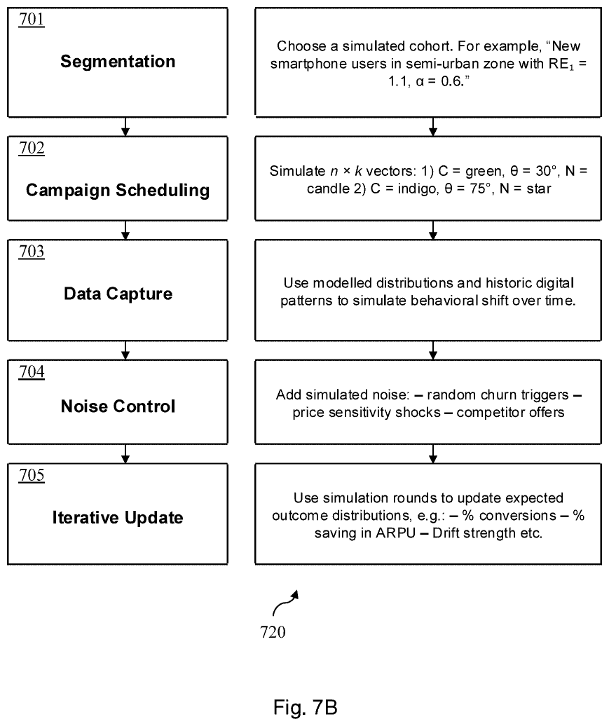

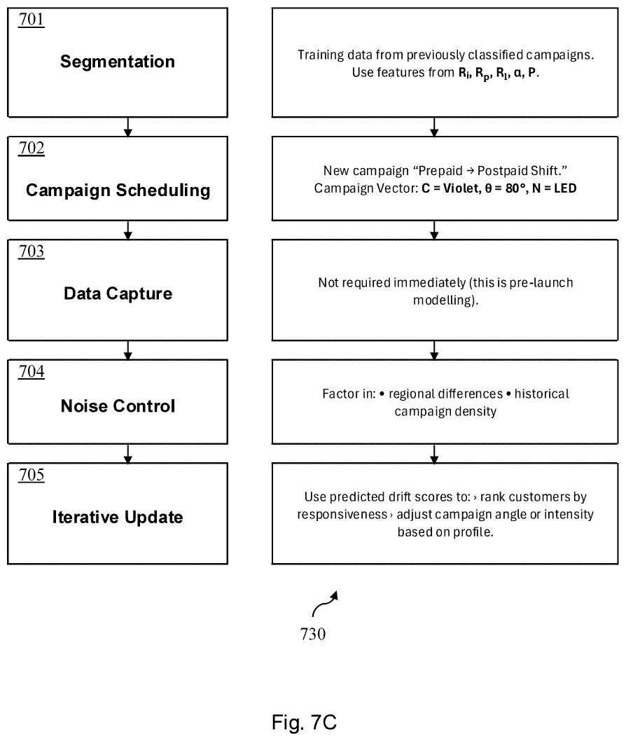

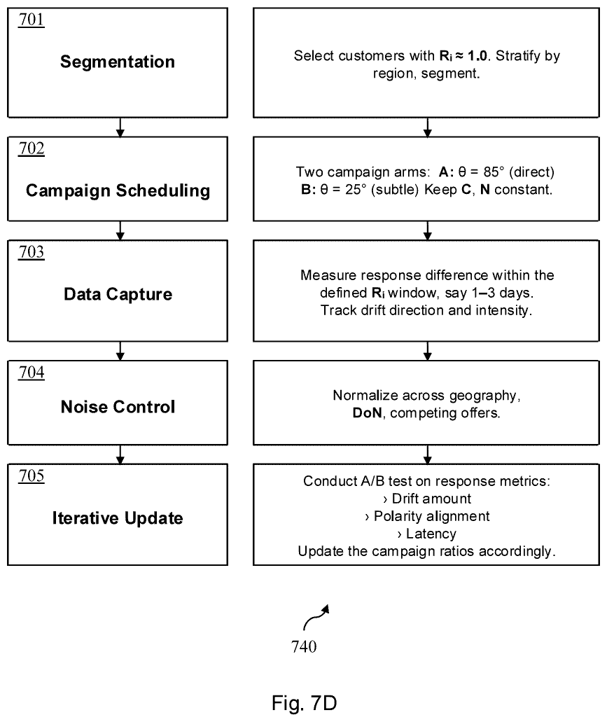

Building upon the mappings illustrated in FIG. 5A-5C, the disclosed system may organize its operational logic into the four primary domains of the disclosure: Campaign Encoding and Parameters (CEP), Customer Trait Representation (CTR), Behavioral Response Capture (BRC), and Environmental and Noise Modeling (ENM), which is further defined in relation to domain structure 520. These domains together provide the structural foundation for experimentation and interpretation within the optical-wave simulation framework. Within CEP, campaign vectors can be geometrically defined according to a quadrant-based engagement framework that classifies interactions by intent and initiation: customer-initiated interactions with known intent are modeled at or near an angle of incidence of 90°, while marketer-initiated outreach with unknown intent is modeled at lower θ values, thereby encoding the degree of alignment between audience readiness and campaign force. The CTR domain parameterizes each customer vector using the optical variables RIᵢ, RPᵢ, RLᵢ, αᵢ, and ρᵢ, enabling the system to maintain a dynamic, multi-dimensional representation of receptivity and behavioral drift. The BRC domain anchors measurement to two normalized key performance indicators—Average Revenue Per User (ARPU) and Customer Satisfaction (CSAT)—serving as reference axes for quantifying polarity and magnitude of response within each observation window. Finally, the ENM domain models stochastic environmental effects through explicit differentiation between induced noise, intentionally introduced to test hypotheses and model sensitivity, and involuntary noise, naturally arising from market competition, external shocks, or overlapping campaigns. This structured integration of domains, geometric engagement logic, KPI validation, and noise taxonomy enables the disclosure's framework to progress seamlessly from optical parameterization to interactive visualization and real-world experimentation, as described in FIG. 6A-7D.

Turning to FIGS. 6A-B, illustrated therein are graphical interface representations illustrating a campaign configuration screen of a workbench of the disclosed systems and methods. Generally, selectable parameters for color, angle, position, and spread of campaigns, with corresponding export and summary control panels 601-603 may be visible on such an interface. These may be understood as exemplary user interface representations 600 of a simulation and visualization environment for configuring, executing, and observing campaign interactions within the system and method for optical-wave modeling of customer behavior in marketing ecosystems of the disclosure. The interface is preferably implemented as a module within the GUI Workbench 350 of FIG. 4, allowing human operators to define campaign parameters, observe modeled audience interactions, and export performance statistics or cohort-level results. Interface 600 may generally comprise three principal panels: a control panel 601, a visualization viewport 602, and a summary and export panel 603. Control panel 601 enables selection and configuration of one or more campaign instances, such as Campaign 1 and Campaign 2, each parameterized according to the optical analogues defined in FIG. 5A-5C. Configurable attributes may include color (C) corresponding to campaign type or behavioral drift intent, angle representing direction of influence, position representing target segment alignment, and spread representing amplitude or reach. Each campaign thus serves as a simulated light emitter within the optical environment. Visualization viewport 602 may display a graphical depiction of the active simulation. In the example of FIG. 6A, a light emitter 621 projects one or more beams of campaign influence 623, 624 toward a modeled audience field 625, comprising multiple customer entities 626a, 626b each having optical properties (RIᵢ, RPᵢ, RLᵢ, αᵢ, ρᵢ) as previously defined. The display allows visualization of propagation paths, refraction points, and interaction geometry as campaigns traverse the audience surface. The interface may render these as dynamic animations or static representations of instantaneous campaign-to-customer interactions. As illustrated in the configuration shown in FIG. 6A, a baseline or single-source condition may be represented, where each campaign vector is propagated independently without modeled environmental interference. Operators may use this setup to examine direct behavioral alignment and parameter sensitivity across defined cohorts, simulating idealized propagation without overlapping campaign fields. In contrast, FIG. 6B illustrates an overlap or interference scenario, wherein multiple campaign sources such as light emitter 621 and additional beams or angles of incidence 623, 624, produce a combined interference field 627. This interference field visualizes the aggregate behavioral modulation within audience field 625, wherein zones of constructive interference represent enhanced engagement or synergy, while destructive interference indicates fatigue, saturation, or conflicting messaging. The resulting visualization reflects the wave-based interaction patterns generated by concurrent or sequential campaigns within the disclosure's Environmental and Noise Modeling (ENM) domain. The summary panel 603 provides real-time metrics and export functionality, including user-selectable options such as I (Intensity), N (Noise), D (Diffusion), and F (Frequency), each corresponding to an underlying simulation variable. Buttons labeled “Export Stats” and “Export Audience” may enable data extraction of modeled outcomes, including customer-level vectors, response latency distributions, and entropy calculations derived from the simulated field. Collectively, FIG. 6A-6B illustrate how the system allows interactive manipulation of campaign vectors and visualization of their behavioral effects within a simulated optical field. These tools enable users to design, test, and refine marketing experiments using the same conceptual framework described in FIG. 3-5C, providing interpretable visual representations of how campaign energy, direction, and overlap influence audience response patterns and systemic entropy across the simulated population.

Referring now to FIG. 7A-7D, collectively illustrated are exemplary operational workflows demonstrating distinct use cases of the system and method for optical-wave modeling of customer behavior in marketing ecosystems and its reinforcement-driven experimentation framework. Each use case represents a different application layer through which the system observes, classifies, and optimizes marketing dynamics using optical-behavioral analogies. As shown, FIG. 7A depicts a campaign-level testing cycle for segmentation and behavioral classification; FIG. 7B illustrates an adaptive feedback and policy-updating process; FIG. 7C presents a cohort-level optimization routine for concurrent campaign interference analysis; and FIG. 7D demonstrates long-term entropy reduction and performance alignment through iterative learning. Taken together, these workflows describe how the disclosed system transitions from observational analysis to autonomous adaptation, thereby linking simulated optical behavior with measurable, real-world marketing improvement across time and population scales.

Turning to FIG. 7A, illustrated therein is a flow diagram representing a use case for real-world campaign testing. FIG. 7A generally illustrates how a user of the disclosed system may study segmentation 701, campaign scheduling 702, data capture 703, noise control 704, and iterative update 705 for classifying customer response types such as aligned absorber or inverted reflector. FIG. 7A illustrates flow diagram 710 representing a first exemplary use case for real-world campaign testing and response classification under the framework within the disclosed system and method for optical-wave modeling of customer behavior in marketing ecosystems. As shown, the process proceeds through a sequence of stages including segmentation 701, campaign scheduling 702, data capture 703, noise control 704, and iterative update 705, by which the system classifies customer response types such as aligned absorber, inverted reflector, or delayed responder. The workflow illustrates how behavioral data may be collected, filtered, and analyzed through successive optical-behavioral transformations to generate refined behavioral taxonomies. Beginning in the segmentation 701 stage, customers are first grouped according to previously inferred or observed parameters, specifically refractive index (RIᵢ) and reflection polarity (RPᵢ). These attributes, derived from earlier campaign interactions, allow the system to distinguish low-Rᵢ likely reflectors from high-Rᵢ potential absorbers or similar behavioral archetypes. This grouping ensures that experimental and control populations are statistically comparable before exposure to new stimuli. In the campaign scheduling 702 stage, the experimentation agent configures and deploys one or more controlled campaign vectors defined by known optical parameters, such as color (C), angle of incidence (θ), and intensity (W), selected from the codified hierarchy described in FIG. 5C. For instance, an illustrative configuration may specify a “Blue, 45° incidence, moderate-intensity LED” campaign corresponding to a strategic repositioning effort with strong directional drift. These predefined campaign vectors enable measurable, repeatable experimentation under the optical simulation paradigm. During data capture 703, the system monitors behavioral responses within one or more observation windows (N time-windows, e.g., n-n₁ days). Within these windows, changes in key performance indicators (e.g., ARPU, CSAT, churn probability, usage volume) are tracked and mapped to corresponding updates in RPᵢ, αᵢ, and ρᵢ. This stage yields the raw empirical evidence necessary to quantify behavioral drift, response latency, and alignment across campaign-recipient interactions. In the noise control 704 stage, data streams are filtered to exclude known confounders and environmental artifacts (e.g., network outages, concurrent product launches, or overlapping holiday periods) that could distort signal integrity. These filtering steps parallel the optical-model concept of isolating external interference to preserve the fidelity of observed reflection and absorption phenomena. Finally, in the iterative update 705 stage, the system recalculates each customer's optical parameters and reclassifies them into response archetypes. Classification logic distinguishes, for example: (a) Aligned Absorber (customers exhibiting positive polarity RPᵢ=+1 and high absorption αᵢ values); (b) Inverted Reflector (customers responding counter to campaign intent RPᵢ=−1 and high reflection ρᵢ); and (c) Delayed Responder (customers exhibiting significant latency RLᵢ>>Δt threshold). These classes may collectively represent the behavioral taxonomy produced by the disclosure's experimentation agent, as described herein. The resulting dataset provides both immediate interpretive value and long-term model-training benefit. It allows marketers to distinguish between superficially similar outcomes that stem from different underlying behaviors (e.g., two customers who both converted but via opposite response polarities). This granular classification forms the foundation for AI-based response modeling, predictive targeting, and exclusion logic within subsequent campaign cycles, thereby reducing wasted effort and aligning marketing energy with the most receptive segments.

Turning to FIG. 7B, illustrated therein is another flow diagram representing a use case for simulated cohort experimentation in simulation process 720 for pre-launch campaign testing using the system and method for optical-wave modeling of customer behavior in marketing ecosystems of the disclosure. FIG. 7B may generally illustrate how the system may simulate user behavior across segmentation 701, campaign scheduling 702, data capture 703, noise control 704, and iterative update 705 stages in order to evaluate campaign outcomes before real-world deployment. In segmentation 701, a simulated cohort may be selected from modeled subscriber data. For instance, a user may define a virtual segment such as “new smartphone users in a semi-urban zone” characterized by representative parameters, such as relative exposure (RE₁=1.1) and attenuation coefficient (α=0.6). The system may synthesize synthetic individuals with probabilistic traits drawn from prior distributions, ensuring statistical consistency with historical behavioral patterns. In campaign scheduling 702, simulated campaign vectors can be generated, representing varying marketing interventions. Each vector may include color code (C), angle of incidence (θ), and nominal symbol (N) corresponding to specific campaign archetypes. For example, a first campaign vector may be defined by C=green, θ=30°, N=candle, while a second may be C=indigo, θ=75°, N=star. The simulated vectors represent the spectrum of marketing tones, intensities, and media compositions to be tested virtually. In data capture 703, modeled distributions and historic digital activity patterns can be employed to emulate behavioral drift over time. The user agent may track virtual responses to campaign exposures and record synthetic engagement signals (e.g., open rates, response latency, or churn probabilities) within a time-evolving digital ecosystem. This can enable a continuous feedback dataset that represents expected real-world reaction curves. In noise control 704, the system can introduce simulated disturbances to reflect market volatility and stochastic human behavior. This may include random churn triggers, transient price sensitivity shocks, and external competitor offers. The introduction of controlled noise allows robustness testing of each campaign scenario, assessing whether observed results persist under realistic variability conditions. In iterative update 705, successive simulation rounds can be executed to refine the outcome distributions. The model may recalculate expected metrics such as percentage conversions, savings in average revenue per user (ARPU), or drift strength after each iteration. Convergence analysis across rounds may be used to estimate confidence bounds on potential campaign outcomes and to identify optimal configurations of C, θ, and N vectors. The overall simulation process 720 thus enables a “what-if” operational mode in which marketing teams may virtually test and tune campaign strategies prior to live execution. By performing iterative refinement under controlled simulated noise and parameter variation, the system provides quantifiable insight into likely real-world performance, thereby de-risking costly campaign rollouts and supporting data-driven decision making.

Turning to FIG. 7C, illustrated therein is yet another flow diagram representing a use case for predictive modeling and pre-launch campaign evaluation for campaign optimization based on expected customer drift and responsiveness. FIG. 7C generally illustrates how the disclosed system may use previously classified campaign outcomes to generate predictive drift scores and dynamically adjust future campaign parameters across segmentation 701, campaign scheduling 702, data capture 703, noise control 704, and iterative update 705 stages. In segmentation 701, the system can retrieve training data from prior campaigns that have been previously classified and modeled. Each record may include features derived from interaction vectors such as initial responsiveness (Rᵢ), propagated response (Rₚ), latent response (R₁), attenuation coefficient (α), and polarization index (P). These features form a multidimensional baseline of customer and campaign traits from which predictive models are trained. In campaign scheduling 702, a new campaign instance can be introduced for simulation or prediction. For illustration, a campaign may represent a “Prepaid to Postpaid Shift” initiative, modeled using a campaign vector defined by C=violet, θ=80°, and N=LED. These vector components correspond to campaign tone, angle of approach, and nominal symbol, respectively, and together define the simulated marketing condition under which the predictive model operates. In data capture 703, real-time collection may be deferred because the present phase involves pre-launch modeling. Instead, the system can rely on previously observed data distributions and learned feature weights to infer likely behavioral outcomes. The model thus may operate on historical and synthetic datasets rather than requiring active event data during this stage, demonstrating the disclosed system and method's versatility. In noise control 704, the model can incorporate contextual modifiers to ensure regional and temporal realism. These modifiers may include regional differences in customer sensitivity, historical campaign density, or varying exposure to prior offers. By introducing such conditional parameters, the model adjusts predicted drift likelihoods to reflect the heterogeneous structure of the customer base. In iterative update 705, predicted drift scores can be generated for each customer and used to rank them by expected responsiveness. The system may then adjust campaign vectors dynamically (e.g., modifying campaign angle θ or intensity weight W) to optimize alignment between campaign delivery and individual customer profiles. Over successive iterations, these updates may refine targeting accuracy and reduce inefficiencies in message distribution. The predictive modeling process 730 thus serves as a decision-support mechanism for pre-launch campaign configuration. By leveraging historic classifications, feature-based modeling, and regionally weighted noise control, the system enables marketers to prioritize responsive segments, avoid low-yield zones, and dynamically tune campaign vectors. This process contributes to precision marketing, improved conversion outcomes, and overall optimization of marketing resource allocation.

Turning to FIG. 7D illustrated therein is yet another flow diagram representing a use case for hypothesis testing process 740 for empirical validation of marketing assumptions using the system and method for optical-wave modeling of customer behavior in marketing ecosystems of the disclosure. FIG. 7D generally illustrates how the system may perform controlled A/B-style experimentation across segmentation 701, campaign scheduling 702, data capture 703, noise control 704, and iterative update 705 to verify causal relationships between campaign configurations and customer responses. In segmentation 701, customers can be selected based on pre-defined behavioral similarity metrics, as in previous examples. For example, the system may select customers with initial response intensity Rᵢ approximately equal to 1.0, indicating baseline responsiveness. Cohorts may be stratified by geography, region, or demographic segment to maintain statistical balance between experimental arms. This ensures comparability of treatment effects and minimizes sampling bias. In campaign scheduling 702, the experiment can be structured into two or more campaign arms, each representing a distinct marketing tactic. For instance, Campaign A may use a direct approach characterized by θ=85°, while Campaign B uses a subtler approach characterized by θ=25°, with color code (C) and nominal symbol (N) held constant. This controlled differentiation isolates the impact of campaign angle θ on customer response patterns. In data capture 703, customer reactions may be recorded within a defined Rᵢ observation window, such as one to three days following exposure. The system tracks direction and magnitude of behavioral drift, response latency, and other key performance indicators (KPIs) such as message engagement or purchase activity. These data points are aggregated to measure differences between treatment arms with respect to the targeted behavioral outcome. In noise control 704, results can be normalized to account for extraneous variables, including geography, degree of neighborhood density (DoN), and exposure to competing offers. The normalization process adjusts for environmental effects and ensures that observed differences between campaign arms are attributable primarily to the tested variable (e.g., θ differentiation) rather than uncontrolled external factors. Then, in iterative update 705, statistical comparisons can be performed on collected response metrics, including drift amount, polarity alignment, and latency. Based on the significance of observed differences, the system may either validate or reject the working hypothesis. Campaign ratios are then updated accordingly, adjusting weighting of direct versus subtle approaches in future operations. Over successive rounds, the agent refines its decision rules, continuously improving its predictive accuracy and campaign recommendation logic. Hypothesis testing process 740 thus enables scientific validation of marketing strategies through structured experimentation. By embedding A/B test design, environmental normalization, and statistical evaluation into the simulation framework, the system allows marketers to replace intuition with empirically validated behavioral insight. Confirmed hypotheses may subsequently be codified into the campaign design library for automated reuse in other exemplary variations of the disclosed system and method for optical-wave modeling of customer behavior in marketing ecosystems.

With respect to the above description then, it is to be realized that the optimum methods, systems, apparatuses, components, and their relationships, including variations in system configuration, machine architecture, scale, materials, geometric form, spatial arrangement, operational logic, control sequence, and interconnection, are intended to be encompassed by the present disclosure. Such variations may include but are not limited to differences in hardware implementation (e.g., edge devices, servers, microcontrollers, GPU or TPU clusters, quantum or neuromorphic processors), network configuration (e.g., LAN, WAN, internet, mesh, or hybrid networks), and software infrastructure (e.g., monolithic, containerized, or micro-service-oriented frameworks). Likewise, embodiments may vary with respect to the order of operation, assembly, and degree of integration between modules, whether executed as local software, distributed cloud services, or hybrid architectures. The type, size, and nature of database systems or data stores (e.g., relational, non-relational, time-series, graph, vector, or federated) may differ without departing from the scope of the present disclosure. The form, encoding, or data-type of stored information may include text, numeric, categorical, multimedia, streaming telemetry, or other machine-readable formats.

In alternate embodiments, the disclosed system and method may be adapted for any digital or physical domain in which entity interactions, behavioral signals, or contextual events can be observed or simulated. Additional engagements, transactions, or customer-journey events may include, without limitation, social-media activity (posts, follows, reactions), email and SMS correspondence, call-center interactions, live-chat or chatbot dialogues, software installations and telemetry from mobile or desktop applications, in-store or online purchases, referral or affiliate actions, loyalty-program participation, gaming behavior, financial transactions, or sensor-based interactions within connected devices or vehicles. Variation may exist among these engagements in the frequency, weighting, or algorithmic importance assigned thereto by the learning engine. The disclosed framework is not limited to a specific business sector, platform, or communication medium, but may be applied to telecommunications, banking and finance, healthcare, insurance, energy, transportation, agriculture, manufacturing, education, public utilities, entertainment, retail, hospitality, and government or civic-engagement systems. In further embodiments, the optical-wave analogies may be extended to non-marketing domains, including cybersecurity threat modeling, network optimization, or predictive maintenance, wherein wave-based propagation models are used to infer sensitivity, resistance, or diffusion characteristics across non-human systems.

The foregoing description and drawings comprise illustrative embodiments of the present disclosure. Having thus described certain exemplary embodiments, it should be noted by those ordinarily skilled in the art that the foregoing disclosures are exemplary only and that numerous modifications, substitutions, and adaptations may be made without departing from the scope of the present disclosure. Merely listing or numbering the steps of a method in a certain order does not constitute a limitation on the order of performance unless explicitly recited in the claims. Many modifications and other embodiments of the disclosure will come to mind to one ordinarily skilled in the art to which this disclosure pertains, having the benefit of the teachings presented herein. Although specific terms may be employed for clarity, they are used in a descriptive sense only and not for purposes of limitation. Accordingly, it is intended that all such equivalents, alterations, and variations as fall within the spirit and scope of the appended claims are embraced thereby, and that the present disclosure is not limited to the specific embodiments illustrated and described herein.

1. A computer-implemented system for simulating and analyzing marketing interactions across a plurality of entities to infer customer sensitivity and reciprocity, the system comprising:
a data processing unit in receipt of a plurality of customer-business interaction stream data and configured to generate a plurality of simulated light waves varying in a color, an intensity, and an angle of incidence, each simulated light wave corresponding to a marketing initiative;
a virtual medium module within a digital environment, said virtual medium representing a plurality of customer behaviors of said stream data as an optical medium having a variable refractive index (RIᵢ), a reflection polarity (RPᵢ), a response latency (RLᵢ), and an absorption and reflection coefficient (αᵢ, ρᵢ) associated for a plurality of entities of said stream data;
a simulation engine configured to propagate the simulated light waves through said virtual medium and to produce an at least one of a reflection, a refraction, and a interference pattern that represent a plurality of entity-level responses to an at least one marketing stimuli;
a noise engine configured to introduce and distinguish between an induced noise corresponding to a controlled experimental perturbation and an involuntary noise corresponding to one of an external effect and a competitive market effect;
a pattern analysis module configured to interpret at least one of said reflection, said refraction, and said interference pattern and to classify an at least one entity response of said stream data according to a behavioral archetype from a group of archetypes, the group consisting of an aligned absorber, an inverted reflector, and a delayed responder;
a reinforcement learning engine coupled to said pattern analysis module and configured to iteratively adjust a plurality of mappings between a plurality of simulated light wave parameters and a plurality of observed response outcomes in said stream data to improve an accuracy of inferred customer sensitivity and a marketing reciprocity; and
a graphical user interface (GUI) workbench configured to display an at least one of a simulation parameter and a visualization of wave interactions based on the inferred classifications;
wherein the system is further configured to ingest said stream data, encode said stream data into corresponding optical-analogy parameters, and output an at least one prescriptive recommendation for a campaign timing, a campaign tone, and a campaign intensity to reduce q marketing noise and enhance an overall marketing effectiveness.

2. The system of claim 1, wherein said simulation engine further comprises a quadrant-based engagement framework configured to classify each of said customer-business interactions according to whether a customer intent is known and whether the interaction is customer-initiated, such that an angle of incidence of approximately 90 degrees corresponds to a customer-initiated interaction with a known intent and a progressively lower angle corresponds to a marketer-initiated interactions with an unknown intent.

3. The system of claim 2, wherein said reinforcement learning engine further comprises a clustering module configured to organize said plurality of entities into cohorts based on a similarity of said refractive index (RIᵢ), said reflection polarity (RPᵢ), and said response latency (RLᵢ) to support an adaptive campaign calibration.

4. The system of claim 3, wherein said noise engine is further configured to categorize said induced noise and said involuntary noise into a solo, a multiple, and an overlapping ripple type by analyzing a plurality of changes in said customer-business interaction stream data in at least one dimension from a group of dimensions, the group consisting of a behavioral dimension, a spend dimension, a purchase dimension, and an engagement dimension.

5. The system of claim 4, wherein said reinforcement learning engine is further configured to compute a marketing entropy metric derived from variations in said reflection polarity (RPᵢ), said absorption coefficient (αᵢ), and said reflection coefficient (ρᵢ), and to minimize said entropy through a plurality of successive policy updates.

6. The system of claim 5, wherein said pattern analysis module is further configured to generate a predictive drift score for each entity based on a combination of said refractive index (RIᵢ), said reflection polarity (RPᵢ), said response latency (RLᵢ), and said absorption and reflection coefficients (αᵢ, ρᵢ).

7. The system of claim 6, wherein said graphical user interface (GUI) workbench is further configured to visualize a constructive interference zone and a destructive interference zones corresponding respectively to a positive campaign synergy and an audience fatigue within said virtual medium.

8. The system of claim 7, wherein said pattern analysis module and said reinforcement learning engine are jointly configured to evaluate a campaign effectiveness against a plurality of normalized key performance indicators including an Average Revenue Per User (ARPU) score and a Customer Satisfaction (CSAT) score.

9. The system of claim 8, wherein said data processing unit is further configured to normalize said stream data for seasonal, geographic, and macroeconomic variance prior to encoding said optical-analogy parameters.

10. The system of claim 9, wherein said graphical user interface (GUI) workbench further comprises an export utility configured to output a campaign configuration data, an entropy report, and a behavioral classification result for a subsequent hypothesis testing and a reinforcement model retraining.

11. A computer-implemented method for simulating and analyzing marketing interactions across a plurality of entities to infer customer sensitivity and reciprocity, the method comprising the steps of:
receiving, by a data processing unit, a plurality of customer-business interaction stream data;
generating, by said data processing unit, a plurality of simulated light waves varying in a color, an intensity, and an angle of incidence, each simulated light wave corresponding to a marketing initiative;
representing, within a virtual medium module of a digital environment, a plurality of customer behaviors of said stream data as an optical medium having a variable refractive index (RIᵢ), a reflection polarity (RPᵢ), a response latency (RLᵢ), and an absorption and reflection coefficient (αᵢ, ρᵢ) associated for a plurality of entities of said stream data;
propagating, by a simulation engine, said simulated light waves through said virtual medium to produce at least one of a reflection, a refraction, and an interference pattern representing a plurality of entity-level responses to at least one marketing stimulus;
introducing, by a noise engine, an induced noise corresponding to a controlled experimental perturbation and an involuntary noise corresponding to one of an external effect and a competitive market effect;
interpreting, by a pattern-analysis module, at least one of said reflection, said refraction, and said interference pattern and classifying at least one entity response of said stream data according to a behavioral archetype selected from a group consisting of an aligned absorber, an inverted reflector, and a delayed responder;
iteratively adjusting, by a reinforcement-learning engine coupled to said pattern-analysis module, a plurality of mappings between a plurality of simulated light-wave parameters and a plurality of observed response outcomes in said stream data to improve an accuracy of inferred customer sensitivity and marketing reciprocity; and
displaying, by a graphical user interface (GUI) workbench, at least one of a simulation parameter and a visualization of wave interactions based on the inferred classifications;
wherein said method further comprises ingesting said stream data, encoding said stream data into corresponding optical-analogy parameters, and outputting at least one prescriptive recommendation for a campaign timing, a campaign tone, and a campaign intensity to reduce marketing noise and enhance an overall marketing effectiveness.

12. The method of claim 11, further comprising classifying each of said customer-business interactions according to a quadrant-based engagement framework that distinguishes whether a customer intent is known and whether the interaction is customer-initiated, such that an angle of incidence of approximately 90 degrees corresponds to a customer-initiated interaction with a known intent and progressively lower angles correspond to marketer-initiated interactions with an unknown intent.

13. The method of claim 12, further comprising organizing said plurality of entities into cohorts based on a similarity of said refractive index (RIᵢ), said reflection polarity (RPᵢ), and said response latency (RLᵢ) to support an adaptive campaign calibration by said reinforcement-learning engine.

14. The method of claim 13, further comprising categorizing said induced noise and said involuntary noise into a solo, a multiple, and an overlapping ripple type by analyzing a plurality of changes in said customer-business interaction stream data in at least one dimension selected from a group consisting of a behavioral dimension, a spend dimension, a purchase dimension, and an engagement dimension.

15. The method of claim 14, further comprising computing, by said reinforcement-learning engine, a marketing-entropy metric derived from variations in said reflection polarity (RPᵢ), said absorption coefficient (αᵢ), and said reflection coefficient (ρᵢ), and minimizing said entropy through a plurality of successive policy updates.

16. The method of claim 15, further comprising generating, by said pattern-analysis module, a predictive drift score for each entity based on a combination of said refractive index (RIᵢ), said reflection polarity (RPᵢ), said response latency (RLᵢ), and said absorption and reflection coefficients (αᵢ, ρᵢ).

17. The method of claim 16, further comprising visualizing, by said GUI workbench, a constructive-interference zone and a destructive-interference zone corresponding respectively to a positive campaign synergy and an audience fatigue within said virtual medium.

18. The method of claim 17, further comprising evaluating, by said pattern-analysis module and said reinforcement-learning engine, a campaign effectiveness against a plurality of normalized key-performance indicators including an Average Revenue Per User (ARPU) score and a Customer Satisfaction (CSAT) score.

19. The method of claim 18, further comprising normalizing, by said data-processing unit, said stream data for seasonal, geographic, and
macroeconomic variance prior to encoding said optical-analogy parameters.

20. The method of claim 19, further comprising exporting, by said GUI workbench, a campaign-configuration data set, an entropy report, and a behavioral-classification result for a subsequent hypothesis testing and a reinforcement-model retraining.
